(19) United States
(12) Patent Application Publication
(10) Pub. No.: US 2020/0356124 A1
(43) Pub. Date: Nov. 12, 2020

(54) ELECTRONIC PLUMBING FIXTURE FITTING INCLUDING INSTALLATION CHECK SYSTEM

(71) Applicant: FB Global Plumbing Group LLC, North Olmsted, OH (US)

(72) Inventors: Thomas R. Bresson, Brunswick, OH (US); Brian Patrick Frackelton, Macedonia, OH (US); George John Polly, Brecksville, OH (US)

(21) Appl. No.: 16/870,262

(22) Filed: May 8, 2020

Related U.S. Application Data
(60) Provisional application No. 62/982,720, filed on Feb. 27, 2020.
(60) Provisional application No. 62/845,588, filed on May 9, 2019.

(51) Int. Cl. G05D 23/19; E03B 7/07

(52) U.S. Cl. CPC G05D 23/1917; E03B 7/075; G05D 23/1919

(57) ABSTRACT

The present invention provides an electronic plumbing fixture fitting including an installation check system. The installation check system includes a mechanism to detect if a hot water line is connected to a hot water supply and a cold water line is connected to a cold water supply, and a mechanism to correct the connection of the hot water line to the hot water supply and the connection of the cold water line to the cold water supply if the hot water line was not properly connected to the hot water supply and the cold water line was not properly connected to the cold water supply during installation of the electronic plumbing fixture fitting.

### CROSS-REFERENCE TO RELATED APPLICATIONS

This application claims the benefit of U.S. Provisional Application No. 62/845,588, filed May 9, 2019, and U.S. Provisional Application No. 62/982,720, filed Feb. 27, 2020, the entire disclosures of which are hereby incorporated by reference.

### FIELD

The present invention relates generally to an electronic plumbing fixture fitting and, more particularly, to an electronic plumbing fixture fitting, such as an electronic faucet, including an installation check system.

### BACKGROUND

Electronic plumbing fixture fittings, such as electronic faucets, are well known. Such electronic plumbing fixture fittings are used in residential and commercial applications, such as in kitchens and various other locations. Users desire to install electronic plumbing fixture fittings. Many difficulties can be encountered in installing electronic plumbing fixture fittings.

### SUMMARY

The present invention provides an electronic plumbing fixture fitting including an installation check system.

In an exemplary embodiment, the electronic plumbing fixture fitting comprises a discharge outlet, an electronic valve, a hot water line, a cold water line, a temperature sensor, and a processor. The discharge outlet is operable to deliver water. The electronic valve is operable to permit flow of water through the discharge outlet when the electronic valve is activated and to not permit flow of water through the discharge outlet when the electronic valve is deactivated. The electronic valve is operable to control a temperature of water flowing through the discharge outlet. The hot water line includes an upstream end and a downstream end. The upstream end is operable to connect to a hot water supply. The downstream end is operable to connect to the electronic valve. The hot water line is operable to supply hot water to the electronic valve. The cold water line includes an upstream end and a downstream end. The upstream end is operable to connect to a cold water supply. The downstream end is operable to connect to the electronic valve. The cold water line is operable to supply cold water to the electronic valve. The temperature sensor is operable to detect a temperature of water. The processor is operable to communicate with each of the electronic valve and the temperature sensor regarding a desired temperature of water and the detected temperature of water. The processor is operable to send a signal to the electronic valve to flow water from the cold water line. The electronic valve is operable to receive the signal from the processor and to flow water from the cold water line. The temperature sensor is operable to detect a temperature of water flowing at least one of in the hot water line, in the cold water line, in the electronic valve, and from the electronic valve and to send a signal to the processor indicating the detected temperature. The processor is operable to receive the signal from the temperature sensor and to save the detected temperature as the cold supply temperature. The processor is operable to compare the cold supply temperature to a cold supply temperature threshold. If the cold supply temperature is greater than the cold supply temperature threshold, then the hot water line and the cold water line are reversed.

In an exemplary embodiment, the electronic plumbing fixture fitting comprises a discharge outlet, an electronic valve, a hot water line, a cold water line, a temperature sensor, and a processor. The discharge outlet is operable to deliver water. The electronic valve is operable to permit flow of water through the discharge outlet when the electronic valve is activated and to not permit flow of water through the discharge outlet when the electronic valve is deactivated. The electronic valve is operable to control a temperature of water flowing through the discharge outlet. The hot water line includes an upstream end and a downstream end. The upstream end is operable to connect to a hot water supply. The downstream end is operable to connect to the electronic valve. The hot water line is operable to supply hot water to the electronic valve. The cold water line includes an upstream end and a downstream end. The upstream end is operable to connect to a cold water supply. The downstream end is operable to connect to the electronic valve. The cold water line is operable to supply cold water to the electronic valve. The temperature sensor is operable to detect a temperature of water. The processor is operable to communicate with each of the electronic valve and the temperature sensor regarding a desired temperature of water and the detected temperature of water. The processor is operable to send a signal to the electronic valve to flow water from the hot water line. The electronic valve is operable to receive the signal from the processor and to flow water from the hot water line. The temperature sensor is operable to detect a temperature of water flowing at least one of in the hot water line, in the cold water line, in the electronic valve, and from the electronic valve and to send a signal to the processor indicating the detected temperature. The processor is operable to receive the signal from the temperature sensor and to save the detected temperature as the hot supply temperature. The processor is operable to compare the hot supply temperature to a hot supply temperature threshold. If the hot supply temperature is greater than the hot supply temperature threshold, then the hot water line and the cold water line are not reversed.

In an exemplary embodiment, the electronic plumbing fixture fitting comprises a discharge outlet, an electronic valve, a hot water line, a cold water line, a temperature sensor, and a processor. The discharge outlet is operable to deliver water. The electronic valve is operable to permit flow of water through the discharge outlet when the electronic valve is activated and to not permit flow of water through the discharge outlet when the electronic valve is deactivated. The electronic valve is operable to control a temperature of water flowing through the discharge outlet. The hot water line includes an upstream end and a downstream end. The upstream end is operable to connect to a hot water supply. The downstream end is operable to connect to the electronic valve. The hot water line is operable to supply hot water to the electronic valve. The cold water line includes an upstream end and a downstream end. The upstream end is operable to connect to a cold water supply. The downstream end is operable to connect to the electronic valve. The cold water line is operable to supply cold water to the electronic valve. The temperature sensor is operable to detect a temperature of water. The processor is operable to communicate with each of the electronic valve and the temperature sensor regarding a desired temperature of water and the detected temperature of water. The processor is operable to send a signal to the electronic valve to flow water primarily from the cold water line. The electronic valve is operable to receive the signal from the processor and to flow water primarily from the cold water line. The temperature sensor is operable to detect a temperature of the water flowing at least one of in the hot water line, in the cold water line, in the electronic valve, and from the electronic valve and to send a signal to the processor indicating the detected temperature. The processor is operable to receive the signal from the temperature sensor and to save the detected temperature as the cold water temperature. The processor is operable to send a signal to the electronic valve to flow water primarily from the hot water line. The electronic valve is operable to receive the signal from the processor and to flow water primarily from the hot water line. The temperature sensor is operable to detect a temperature of the water flowing at least one of in the hot water line, in the cold water line, in the electronic valve, and from the electronic valve and to send a signal to the processor indicating the detected temperature. The processor is operable to receive the signal from the temperature sensor and to save the detected temperature as the hot water temperature. The processor is operable to compare the cold water temperature to the hot water temperature. If the cold water temperature is greater than the hot water temperature, then the hot water line and the cold water line are reversed. If the cold water temperature is less than the hot water temperature, then the hot water line and the cold water line are not reversed.

### BRIEF DESCRIPTION OF THE DRAWINGS

FIG. 1 is a schematic illustration of fluidic components of an electronic plumbing fixture fitting according to an exemplary embodiment of the present invention;

FIG. 2 is a schematic illustration of electrical/electronic components of an electronic plumbing fixture fitting according to an exemplary embodiment of the present invention; and

FIG. 3 is an illustration of an electronic faucet according to an exemplary embodiment of the present invention.

### DETAILED DESCRIPTION

The present invention provides an electronic plumbing fixture fitting. In an exemplary embodiment, the electronic plumbing fixture fitting is an electronic faucet. However, one of ordinary skill in the art will appreciate that the electronic plumbing fixture fitting could be an electronic showering system, an electronic showerhead, an electronic handheld shower, an electronic body spray, an electronic side spray, or any other electronic plumbing fixture fitting.

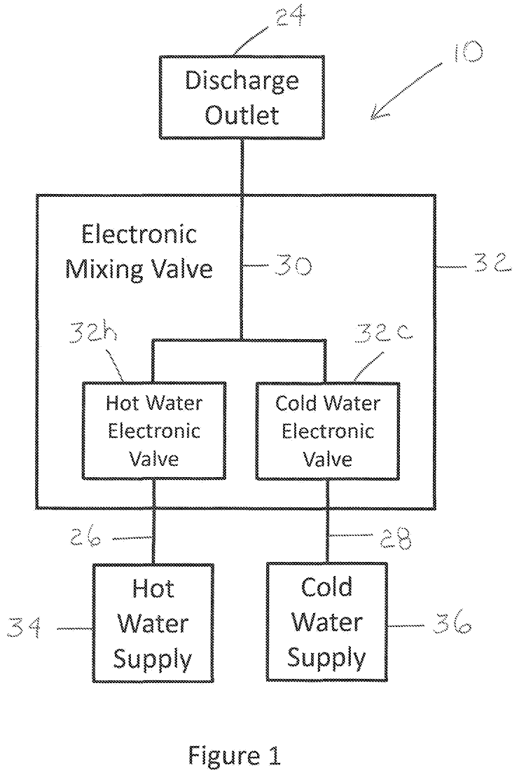

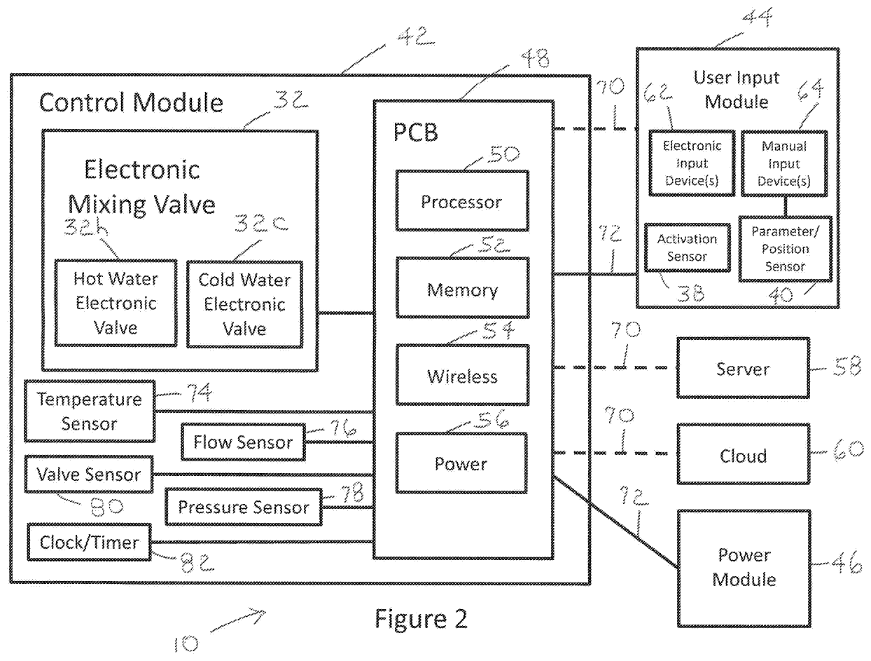

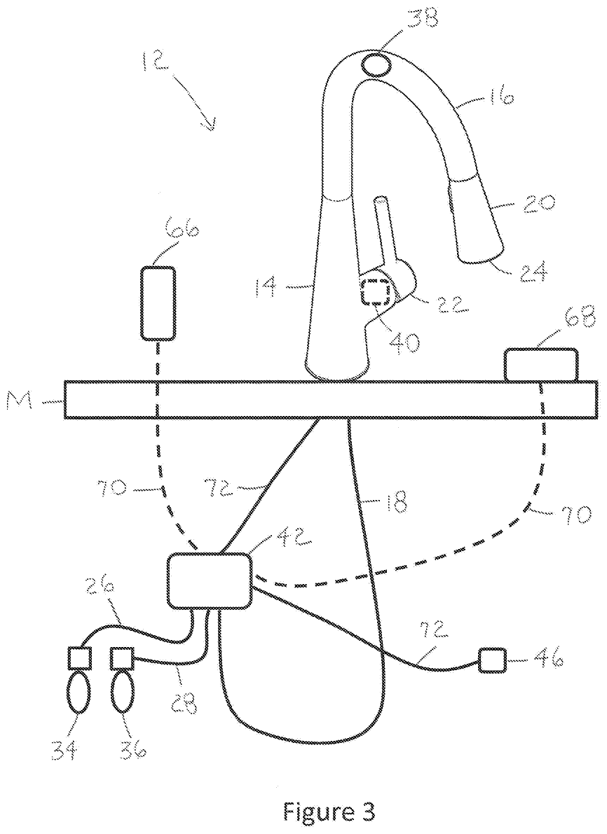

An exemplary embodiment of an electronic plumbing fixture fitting 10, such as an electronic faucet 12, is illustrated in FIGS. 1 and 2. FIG. 1 primarily shows the fluidic components and connections of the electronic plumbing fixture fitting 10, and FIG. 2 primarily shows the electrical/electronic components and connections of the electronic plumbing fixture fitting 10. An exemplary embodiment of the electronic faucet 12 is illustrated in FIG. 3. FIG. 3 shows the fluidic and electrical/electronic components of the electronic faucet 12.

In the illustrated embodiments, as best shown in FIG. 3, the faucet 12 includes a hub 14, a spout 16, a wand hose 18, a wand 20, and a handle 22. An upstream end of the hub 14 is connected to a mounting surface M (such as a counter or sink). An upstream end of the spout 16 is connected to a downstream end of the hub 14. The spout 16 is operable to rotate relative to the hub 14. The wand hose 18 extends through the hub 14 and the spout 16 and is operable to move within the hub 14 and the spout 16. An upstream end of the wand 20 is mounted in a downstream end of the spout 16 and is connected to a downstream end of the wand hose 18. A downstream end of the wand 20 includes a discharge outlet 24 through which water is delivered from the faucet 12. The wand 20 is operable to pull away from the spout 16. The handle 22 is connected to a side of the hub 14 and is operable to move relative to the hub 14. Although the faucet 12 has been described as having a rotatable spout 16, a pull-out or pull-down wand 20, and a handle 22 mounted on the hub 14, one of ordinary skill in the art will appreciate that, in certain embodiments, the spout 16 could be fixed relative to the hub 14, the faucet 12 may not include a wand 20, the handle 22 could be mounted on other locations on the faucet 12 or remote from the faucet 12, the faucet 12 could include more than one handle 22, the handle 22 could be any mechanical actuation device or user interface, and/or the faucet 12 may not include a handle 22.

Additionally, in the illustrated embodiments, as best shown in FIGS. 1 and 3, the fitting 10 and the faucet 12 include a hot water line 26, a cold water line 28, a mixed water line 30, and an electronic valve 32. In the illustrated embodiments, the electronic valve 32 is an electronic mixing valve that includes a hot water electronic valve 32h and a cold water electronic valve 32c.

An upstream end of the hot water line 26 connects to a hot water supply 34, and an upstream end of the cold water line 28 connects to a cold water supply 36. A downstream end of the hot water line 26 connects to the electronic valve 32, and a downstream end of the cold water line 28 connects to the electronic valve 32. More particularly, a downstream end of the hot water line 26 connects to the hot water electronic valve 32h, and a downstream end of the cold water line 28 connects to the cold water electronic valve 32c.

An upstream end of the mixed water line 30 connects to the electronic valve 32. More particularly, an upstream end of the mixed water line 30 connects to the hot water electronic valve 32h and the cold water electronic valve 32c. A downstream end of the mixed water line 30 connects to the discharge outlet 24. In the illustrated embodiments, at least a portion of the mixed water line 30 is the wand hose 18. As stated above, the downstream end of the wand hose 18 connects to the upstream end of the wand 20, and the downstream end of the wand 20 includes the discharge outlet 24 through which water is delivered from the faucet 12.

In the illustrated embodiments, each portion of the hot water line 26, the cold water line 28, and the mixed water line 30 is shown as including at least one hose, pipe, or passage. However, one of ordinary skill in the art will appreciate that each portion of the hot water line 26, the cold water line 28, and the mixed water line 30 could include more than one hose, pipe, or passage. Similarly, each portion of the hot water line 26, the cold water line 28, and the mixed water line 30 could include a combination of hose(s), pipe(s), and/or passage(s). In an exemplary embodiment, the hoses are flexible hoses. However, one of ordinary skill in the art will appreciate that other types of hoses could be used. If a portion of the hot water line 26, the cold water line 28, or the mixed water line 30 includes more than one hose, pipe, and/or passage, the hose(s), pipe(s), and/or passage(s) are connected via connectors. In an exemplary embodiment for the flexible hoses, the connectors are push-fit connectors. However, one of ordinary skill in the art will appreciate that other types of connectors could be used.

When reference is made to one component of the fitting 10 or the faucet 12 connecting to another component of the fitting 10 or the faucet 12, the connection may be direct or indirect. One of ordinary skill in the art will appreciate that additional components may be needed if the connection is indirect.

In the illustrated embodiments, the fitting 10 and the faucet 12 include the electronic valve 32 and, more particularly, the hot water electronic valve 32h and the cold water electronic valve 32c. However, one of ordinary skill in the art will appreciate that the fitting 10 and the faucet 12 could include one or more electronic valves. Additionally, the fitting 10 and the faucet 12 could include one or more mechanical valves, either in parallel or in series with the electronic valve(s). Further, although the fitting 10 and the faucet 12 have been described as including the electronic valve 32 that is an electronic mixing valve, one of ordinary skill in the art will appreciate that the fitting 10 and the faucet 12 could include just the hot water electronic valve 32h or just the cold water electronic valve 32c.

In an exemplary embodiment, the hot water electronic valve 32h and the cold water electronic valve 32c are proportional valves and, more specifically, stepper motor actuated valves. However, one of ordinary skill in the art will appreciate that the hot water electronic valve 32h and the cold water electronic valve 32c could be any type of electronic valves, including, but not limited to, solenoid valves and electronic throttle valves.

In the illustrated embodiments, as best shown in FIG. 3, the fitting 10 and the faucet 12 includes an activation sensor 38, such as a toggle sensor. In an exemplary embodiment, the activation sensor 38 is a proximity sensor and, in particular, an infrared sensor. The activation sensor 38 is also referred to as a latching sensor and a sustained-flow sensor. In the illustrated embodiment, the activation sensor 38 is mounted on an apex of the spout 16. The activation sensor 38 defines an activation zone. In an exemplary embodiment, the activation sensor 38 is operable to activate the hot water electronic valve 32h and the cold water electronic valve 32c when an object enters the activation zone and to deactivate the hot water electronic valve 32h and the cold water electronic valve 32c when the object exits and reenters the activation zone. As used herein, an “object” can be any portion of a user's body or any item used by the user to trigger the activation sensor 38. In an exemplary embodiment, the activation zone extends generally upwardly from the activation sensor 38. Additionally, in an exemplary embodiment, the activation zone has a generally cone-like shape.

As described above, the activation sensor 38 is a proximity sensor and, in particular, an infrared sensor. Proximity sensors are sensors that detect the presence of an object without any physical contact. However, one of ordinary skill in the art will appreciate that the activation sensor 38 could be any type of electronic sensor that can be triggered, including, but not limited to, other proximity sensors, touch sensors, and image sensors. Exemplary electronic sensors include, but are not limited to, electromagnetic radiation sensors (such as optical sensors and radar sensors), capacitance sensors, inductance sensors, piezo-electric sensors, and multi-pixel optical sensors (such as camera sensors). As further described above, the activation sensor 38 is mounted on the apex of the spout 16. However, one of ordinary skill in the art will appreciate that the activation sensor 38 could be mounted in any location on the faucet 12 or in a location remote from the faucet 12.

Similarly, as described above, the activation sensor 38 is a toggle sensor. However, one of ordinary skill in the art will appreciate that the activation sensor 38 could be any type of sensor that provides information useful in determining whether to activate or deactivate the hot water electronic valve 32h and the cold water electronic valve 32c, including, but not limited to, flow sensors, pressure sensors, temperature sensors, and position sensors.

In the illustrated embodiments, the handle 22 operates as it would with a standard faucet. In other words, the handle 22 can be moved between various positions to indicate a desired temperature, flow rate, and/or volume of water discharged from the faucet 12.

In the illustrated embodiments, as best shown in FIG. 3, although the handle 22 does not control a mechanical valve, the handle 22 operates as it would with a standard faucet. In other words, the handle 22 can be moved between various positions to indicate a desired temperature, flow rate, and/or volume of water discharged from the faucet 12.

More specifically, with regard to the temperature of water, the handle 22 can be rotated about a longitudinal axis of a side opening in the hub 14. At one extent of a range of rotation, the position of the handle 22 indicates all hot water (a full hot position). At the other extent of the range of rotation, the position of the handle 22 indicates all cold water (a full cold position). In between the extents of the range of rotation, the position of the handle 22 indicates a mix of hot and cold water (mixed temperature positions) with hotter temperature water as the position nears the full hot extent of the range of rotation and colder temperature water as the position nears the full cold extent of the range of rotation.

With regard to the flow rate/volume of water, the handle 22 can be moved toward and away from the side opening in the hub 14. At one extent of a range of movement, the position of the handle 22 indicates no flow rate/volume of water (a full closed position). At the other extent of the range of movement, the position of the handle 22 indicates full flow rate/volume of water (a full open position). In between the extents of the range of movement, the position of the handle 22 indicates an intermediate flow rate/volume of water (less than full open positions) with reduced flow rate/volume of water as the position nears the full closed extent of the range of movement and increased flow rate/volume of water as the position nears the full open extent of the range of movement.

In an exemplary embodiment, the faucet 12 is operable to detect movement of the handle 22 and to provide information to set at least one parameter of water flowing through the hot water electronic valve 32h and the cold water electronic valve 32c based on the movement of the handle 22. The faucet 12 is operable to detect movement of the handle 22 either directly or indirectly. In an exemplary embodiment, based on the movement of the handle 22, the faucet 12 provides information to set a temperature, flow rate, and/or volume of water flowing through the hot water electronic valve 32h and the cold water electronic valve 32c.

Further, in the illustrated embodiments, as best shown in FIG. 3, the faucet 12 includes a parameter or position sensor 40. In an exemplary embodiment, the parameter or position sensor 40 is operable to detect a state of the handle 22, such as a position or a movement of the handle 22, and to provide information to set at least one parameter of water flowing through the hot water electronic valve 32h and the cold water electronic valve 32c based on the state of the handle 22, such as the position or the movement of the handle 22. The parameter or position sensor 40 is operable to detect the state of the handle 22, such as the position or the movement of the handle 22, ranging from the full hot position through the full cold position and from the full closed position through the full open position. The parameter or position sensor 40 is operable to detect the state of the handle 22, such as the position or the movement of the handle 22, either directly or indirectly. In an exemplary embodiment, based on the state of the handle 22, such as the position or the movement of the handle 22, the parameter or position sensor 40 provides information to set a temperature, flow rate, and/or volume of water flowing through the hot water electronic valve 32h and the cold water electronic valve 32c.

An electronic plumbing fixture fitting, such as an electronic faucet, including a parameter or position sensor that is operable to detect movement of a handle and to provide information to set at least one parameter (such as a temperature and/or a volume) of water flowing through a hot water electronic valve and a cold water electronic valve based on movement of the handle is disclosed in U.S. Pat. No. 9,212,473, assigned to FB Global Plumbing Group LLC, the entire disclosure of which is hereby incorporated by reference.

Further, in the illustrated embodiments, as best shown in FIGS. 2 and 3, the fitting 10 and the faucet 12 include a control module 42, a user input module 44, and a power module 46.

The flow components of the control module 42 include a number of inlets and outlets and a number of flow passages. These inlets/outlets and flow passages enable the easy management of the flow between the incoming flows (i.e., the hot water line 26 and the cold water line 28) and the outgoing flow (i.e., the mixed water line 30 or the wand hose 18).

In the illustrated embodiments, as best shown in FIG. 3, the control module 42 is operable to mount below the mounting surface M (such as the counter or sink). In an exemplary embodiment, the control module 42 is operable to mount on a mounting shank of the fitting 10 or the faucet 12. In the illustrated embodiments, the electronic valve 32 is located inside the control module 42. In the illustrated embodiments, the control module 42 includes a top or first side and a bottom or second side. The first side is opposite the second side. In the illustrated embodiments, the second side includes openings for hoses and flow passages.

In the illustrated embodiments, as best shown in FIG. 2, the control module 42 further includes a number of electronic components. These components enable the operation of the fitting 10 or the faucet 12. More specifically, these components enable the activation, deactivation, and control of the electronic valve 32 through user input. The control module 42 includes the electronic valve 32 and a printed circuit board (“PCB”) 48. In the illustrated embodiments, a number of electronic components are mounted on the PCB 48, including, but not limited to, a processor 50, memory 52, a wireless communication chip 54, and a power port 56. The processor 50 receives signals from and sends signals to the components of the fitting 10 or the faucet 12 to control operation of the fitting 10 or the faucet 12. For example, the processor 50 receives signals from sensors (described above and to be described in greater detail below) and sends signals to the electronic valve 32 to activate, deactivate, and control the electronic valve 32. The memory 52 can save information received from the components of the fitting 10 or the faucet 12. The information can also be saved in remote memory. Exemplary storage locations for the remote memory include the user input module 44 (where the user input module 44 includes memory, such as an Apple iPhone and a Google Android phone), a centralized server provided by the fitting/faucet manufacturer, and a cloud service provided by the fitting/faucet manufacturer or a third party (such as Google, HomeKit, and IFTTT). In the illustrated embodiments, the remote memory includes a server 58 and a cloud 60.

In the illustrated embodiments, as best shown in FIGS. 2 and 3, the user input module 44 provides operational instructions to the electronic components of the fitting 10 or the faucet 12. The user input module 44 can be any module that enables user input. The user input module 44 includes electronic input device(s) 62 and manual input device(s) 64. Exemplary electronic input devices 62 include activation sensors, mobile devices, voice controlled devices, touch screen devices, and push button devices. In the illustrated embodiments, the user input module 44 includes the activation sensor 38, a mobile device 66, and a voice controlled device 68. Exemplary manual input devices 64 include handles and joysticks. In the illustrated embodiments, the user input module 44 includes the handle 22. The user input module 44 receives input from a user and sends signals to the control module 42 or other electronic components of the fitting 10 or the faucet 12 to control operation of the components of the fitting 10 or the faucet 12. For example, the user input module 44 receives input from a user and sends signals to the processor 50 to activate, deactivate, and control the electronic valve 32.

In the illustrated embodiments, some components of the user input module 44 (e.g., the mobile device 66 and the voice controlled device 68) are connected to the control module 42 via a wireless communication connection 70 (such as a Wi-Fi connection), while other components of the user input module 44 (e.g., the activation sensor 38 and the parameter or position sensor 40) are connected to the control module 42 via a hard-wired connection 72. In the illustrated embodiments, some components of the user input module 44 (e.g., the mobile device 66 and the voice controlled device 68) send the signals to and/or receive signals from the processor 50 via the wireless communication connection 70 (such as the Wi-Fi connection), while other components of the user input module 44 (e.g., the activation sensor 38 and the parameter or position sensor 40) send signals to and/or receive signals from the processor 50 via the hard-wired connection 72. However, one of ordinary skill in the art will appreciate that each component of the user input module 44 could be connected to the control module 42 and send signals to and/or receive signals from the processor 50 via any type of connection, including other wireless communication connections, such as Bluetooth, cellular, near field communication (NFC), Zigbee, and Z-Wave, or a hard-wired connection.

In the illustrated embodiments, as best shown in FIG. 3, three electronic input devices 62 and one manual input device 64 are shown, i.e., the activation sensor 38 on the faucet 12, the mobile device 66 that can be held or moved by the user, the voice controlled device 68 located on the mounting surface M, and the handle 22 connected to the hub 14 of the faucet 12 located on the mounting surface M. However, one of ordinary skill in the art will appreciate that the user input module 44 could include any number of components. Moreover, each component of the user input module 44 could be in any location where it can send signals to and/or receive signals from the control module 42 and/or other electronic components of the fitting 10 or the faucet 12, such as the processor 50, or each component of the user input module 44 could be integrally formed with or physically connected to the fitting 10 or the faucet 12.

In the illustrated embodiments, as best shown in FIGS. 2 and 3, the server 58 and the cloud 60 are connected to the control module 42 via the wireless communication connection 70 (such as the Wi-Fi connection).

In the illustrated embodiments, as best shown in FIGS. 2 and 3, the power module 46 provides power to the electrical/electronic components of the fitting 10 or the faucet 12. In the illustrated embodiments, the power module 46 is operable to mount below the mounting surface M. In the illustrated embodiments, the power module 46 is connected to the control module 42 via the hard-wired connection 72. In an exemplary embodiment, the power module 46 includes battery power. In an exemplary embodiment, the power module 46 includes AC power.

During operation of the electronic valve 32, the user activates, deactivates, and controls the electronic valve 32 using the user input module 44. When the user appropriately triggers the user input module 44, the electronic valve 32 is activated, deactivated, or otherwise controlled. For example, the user could trigger the user input module 44 by triggering the activation sensor 38, pressing an appropriate button on the mobile device 66, stating specific commands to the voice controlled device 68, and/or opening, closing, and/or moving the handle 22. For voice control, when the user says “turn on the faucet,” the electronic valve 32 is activated. Similarly, when the user says “turn off the faucet,” the electronic valve 32 is deactivated. Further, when the user says “increase temperature,” “decrease temperature,” “increase flow,” or “decrease flow,” the electronic valve 32 is controlled to accomplish the requested action. The commands can be predetermined. Additionally, the commands can be customizable. For example, the user could activate the electronic valve 32 by saying “start flow” instead of “turn on the faucet.” Similarly, the user could deactivate the electronic valve 32 by saying “stop flow” instead of “turn off the faucet.”

As used herein, “activate a valve” means to move the valve to or maintain the valve in an open position, regardless of the volume or temperature of the flowing water, and “deactivate a valve” means to move the valve to a completely closed position.

When reference is made to activating or deactivating the electronic valve 32 “when the user appropriately triggers the user input module 44,” the electronic valve 32 may be activated or deactivated immediately upon the user input module 44 being triggered or a predetermined period of time after the user input module 44 has been triggered.

In the illustrated embodiments, the fitting 10 and the faucet 12 include sensors. In the illustrated embodiments, the sensors include the activation sensor 38, the parameter or position sensor 40, a temperature sensor 74, a flow sensor 76, a pressure sensor 78, and a valve sensor 80. The activation sensor 38 and the parameter or position sensor 40 were described above. The temperature sensor 74 is operable to detect a temperature of water in the hot water line 26, the cold water line 28, the electronic valve 32, and/or the mixed water line 30 or wand hose 18. The flow sensor 76 is operable to detect a flow rate of water in the hot water line 26, the cold water line 28, the electronic valve 32, and/or the mixed water line 30 or wand hose 18. The pressure sensor 78 is operable to detect a pressure of water in the hot water line 26, the cold water line 28, the electronic valve 32, and/or the mixed water line 30 or wand hose 18. The valve sensor 80 is operable to detect a position of the electronic valve 32 and/or a motor driving the electronic valve 32. The sensors send signals to the processor 50 indicating the detected information.

The information detected by the sensors is used to control the operation of the fitting 10 or the faucet 12. The information detected by the activation sensor 38 can be used to activate and deactivate the fitting 10 or the faucet 12. The information detected by the parameter or position sensor 40 can be used to determine a temperature, flow rate, and/or volume of water desired by the user. The information detected by the temperature sensor 74 can be used to maintain a temperature of water discharged from the fitting 10 or the faucet 12. The information detected by the flow sensor 76 can be used to determine if there is flow or maintain a flow rate of water discharged from the fitting 10 or the faucet 12. The information detected by the pressure sensor 78 can be used to maintain a pressure or determine a volume of water discharged from the fitting 10 or the faucet 12. The information detected by the valve sensor 80 can be used to open and close the electronic valve 32.

In the illustrated embodiments, the fitting 10 and the faucet 12 include a clock/timer 82. The clock/timer 82 is operable to provide a date and a time of an action or to measure time intervals. For example, the clock/timer 82 can provide a date and a time of an activation or a deactivation of the fitting 10 or the faucet 12 or measure a time interval from an activation of the fitting 10 or the faucet 12 through a deactivation of the fitting 10 or the faucet 12.

Installation Check System

In an exemplary embodiment, the fitting 10 or the faucet 12 includes an installation check system.

In an exemplary embodiment, the user installs the fitting 10 or the faucet 12. The installation includes connecting the upstream end of the hot water line 26 to the hot water supply 34, and connecting the upstream end of the cold water line 28 to the cold water supply 36. Additionally, the installation includes connecting the downstream end of the hot water line 26 to the electronic valve 32, and connecting the downstream end of the cold water line 28 to the electronic valve 32. More particularly, the installation includes connecting the downstream end of the hot water line 26 to the hot water electronic valve 32h, and connecting the downstream end of the cold water line 28 to the cold water electronic valve 32c.

In an exemplary embodiment, the installation check system includes a mechanism to detect if the hot water line 26 is connected to the hot water supply 34 and the cold water line 28 is connected to the cold water supply 36, and a mechanism to correct the connection of the hot water line 26 to the hot water supply 34 and the connection of the cold water line 28 to the cold water supply 36 if the hot water line 26 was not properly connected to the hot water supply 34 and the cold water line 28 was not properly connected to the cold water supply 36 during installation of the fitting 10 or the faucet 12.

In an exemplary embodiment, the processor 50 learns a cold supply temperature by sending a signal to the electronic valve 32 to activate and flow cold water. As a result, cold water will be delivered through the discharge outlet 24 of the fitting 10 or the faucet 12. In an exemplary embodiment, all cold water will be delivered through the discharge outlet 24 of the fitting 10 or the faucet 12. The temperature sensor 74 detects the temperature of the water and sends a signal to the processor 50 indicating the detected temperature. The processor 50 receives the signal from the temperature sensor 74. The temperature sensor 74 continues to detect the temperature of the water and to send signals to the processor 50 indicating the detected temperatures, and the processor 50 continues to receive the signals from the temperature sensor 74, until: (1) the detected temperature has become stable (e.g., has not changed for a period of time sufficient to ensure that the detected temperature is approximately equal to a temperature of water from the cold water supply, such as for thirty seconds), (2) the detected temperature has reached a specified temperature (e.g., is below any temperature of water that could be achieved by hot water cooling in the hot water line 26), or (3) water has been flowing for a specified period of time (e.g., a period of time necessary for water sitting in the cold water line 28 to be purged). The processor then saves the detected temperature as the cold supply temperature.

In an exemplary embodiment, the processor 50 learns a hot supply temperature by sending a signal to the electronic valve 32 to activate and flow hot water. As a result, hot water will be delivered through the discharge outlet 24 of the fitting 10 or the faucet 12. In an exemplary embodiment, all hot water will be delivered through the discharge outlet 24 of the fitting 10 or the faucet 12. The temperature sensor 74 detects the temperature of the water and sends a signal to the processor 50 indicating the detected temperature. The processor 50 receives the signal from the temperature sensor 74. The temperature sensor 74 continues to detect the temperature of the water and to send signals to the processor 50 indicating the detected temperatures, and the processor 50 continues to receive the signals from the temperature sensor 74, until: (1) the detected temperature has become stable (e.g., has not changed for a period of time sufficient to ensure that the detected temperature is approximately equal to a temperature of water from the hot water supply, such as for thirty seconds), (2) the detected temperature has reached a specified temperature (e.g., is above any temperature of water that could be achieved by cold water warming in the cold water line 28), or (3) water has been flowing for a specified period of time (e.g., a period of time necessary for water sitting in the hot water line 26 to be purged). The processor then saves the detected temperature as the hot supply temperature.

In an exemplary embodiment, once the processor 50 has learned at least one of the cold supply temperature and the hot supply temperature, the processor 50 determines if the hot water line 26 is connected to the hot water supply 34 and the cold water line 28 is connected to the cold water supply 36 (i.e., if the hot water line 26 and the cold water line 28 are reversed).

In an exemplary embodiment, the processor 50 initially determines if the hot water line 26 and the cold water line 28 are reversed by comparing the cold supply temperature to a cold supply temperature threshold (i.e., a temperature above which the cold water supply 36 is not capable of achieving, such as 100° F.). If the cold supply temperature is greater than the cold supply temperature threshold, then the hot water line 26 and the cold water line 28 are reversed. In this instance (i.e., the lines are reversed), further action needs to be taken (as will be described below). If the cold supply temperature is not greater than or is less than the cold supply temperature threshold, then the hot water line 26 and the cold water line 28 may still be reversed (e.g., if the hot water supply 34 has been depleted). In this instance, the processor 50 then determines if the hot water line 26 and the cold water line 28 are reversed by comparing the cold supply temperature to the hot supply temperature. In an exemplary embodiment, if the cold supply temperature is greater than the hot supply temperature, then the hot water line 26 and the cold water line 28 are reversed. In an exemplary embodiment, if the cold supply temperature is greater than the hot supply temperature by a differential supply temperature threshold (e.g., 15° F.), then the hot water line 26 and the cold water line 28 are reversed. The differential supply temperature threshold eliminates the possibility of the cold supply temperature being greater than the hot supply temperature for a reason other than the hot water line 26 and the cold water line 28 are reversed. In these instances (i.e., the lines are reversed), further action needs to be taken (as will be described below). In an exemplary embodiment, if the cold supply temperature is not greater than or is less than the hot supply temperature, then the hot water line 26 and the cold water line 28 are not reversed. In an exemplary embodiment, if the cold supply temperature is not greater than or is less than the hot supply temperature by the differential supply temperature threshold, then the hot water line 26 and the cold water line 28 are not reversed. In these instances (i.e., the lines are not reversed), no further action needs to be taken.

In an exemplary embodiment, the processor 50 initially determines if the hot water line 26 and the cold water line 28 are reversed by comparing the hot supply temperature to a hot supply temperature threshold (i.e., a temperature above which the cold water supply 36 is not capable of achieving, such as 100° F.). If the hot supply temperature is greater than the hot supply temperature threshold, then the hot water line 26 and the cold water line 28 are not reversed. In this instance (i.e., the lines are not reversed), no further action needs to be taken. If the hot supply temperature is not greater than or is less than the hot supply temperature threshold, then the hot water line 26 and the cold water line 28 may still be reversed. In this instance, the processor 50 then determines if the hot water line 26 and the cold water line 28 are reversed by comparing the cold supply temperature to the hot supply temperature. In an exemplary embodiment, if the cold supply temperature is greater than the hot supply temperature, then the hot water line 26 and the cold water line 28 are reversed. In an exemplary embodiment, if the cold supply temperature is greater than the hot supply temperature by the differential supply temperature threshold (e.g., 15° F.), then the hot water line 26 and the cold water line 28 are reversed. Again, the differential supply temperature threshold eliminates the possibility of the cold supply temperature being greater than the hot supply temperature for a reason other than the hot water line 26 and the cold water line 28 are reversed. In these instances (i.e., the lines are reversed), further action needs to be taken (as will be described below). In an exemplary embodiment, if the cold supply temperature is not greater than or is less than the hot supply temperature, then the hot water line 26 and the cold water line 28 are not reversed. In an exemplary embodiment, if the cold supply temperature is not greater than or is less than the hot supply temperature by the differential supply temperature threshold, then the hot water line 26 and the cold water line 28 are not reversed. In these instances (i.e., the lines are not reversed), no further action needs to be taken.

In an exemplary embodiment, the processor 50 initially determines if the hot water line 26 and the cold water line 28 are reversed by comparing the cold supply temperature to the hot supply temperature. In an exemplary embodiment, if the cold supply temperature is greater than the hot supply temperature, then the hot water line 26 and the cold water line 28 are reversed. In an exemplary embodiment, if the cold supply temperature is greater than the hot supply temperature by the differential supply temperature threshold (e.g., 15° F.), then the hot water line 26 and the cold water line 28 are reversed. Again, the differential supply temperature threshold eliminates the possibility of the cold supply temperature being greater than the hot supply temperature for reasons other than the hot water line 26 and the cold water line 28 are reversed. In these instances (i.e., the lines are reversed), further action needs to be taken (as will be described below). In an exemplary embodiment, if the cold supply temperature is not greater than or is less than the hot supply temperature, then the hot water line 26 and the cold water line 28 are not reversed. In an exemplary embodiment, if the cold supply temperature is not greater than or is less than the hot supply temperature by the differential supply temperature threshold, then the hot water line 26 and the cold water line 28 are not reversed. In these instances (i.e., the lines are not reversed), no further action needs to be taken.

In an exemplary embodiment, the processor 50 learns a cold water temperature by sending a signal to the electronic valve 32 to activate and flow water primarily from the cold water line 28. As a result, primarily cold water will be delivered through the discharge outlet 24 of the fitting 10 or the faucet 12. As used herein, “flow water primarily from the cold water line” and “primarily cold water” mean flowing water and water that include more cold water than hot water. The temperature sensor 74 detects the temperature of the water and sends a signal to the processor 50 indicating the detected temperature. The processor 50 receives the signal from the temperature sensor 74. The temperature sensor 74 continues to detect the temperature of the water and to send signals to the processor 50 indicating the detected temperatures, and the processor 50 continues to receive the signals from the temperature sensor 74, until: (1) the detected temperature has become stable (e.g., has not changed for a period of time sufficient to ensure that the detected temperature is approximately equal to a temperature of the flowing water, such as for thirty seconds), (2) the detected temperature has reached a specified temperature (e.g., is below any temperature of water that could be achieved by hot water cooling in the hot water line 26), or (3) water has been flowing for a specified period of time (e.g., a period of time necessary for water sitting in the cold water line 28 to be purged). The processor then saves the detected temperature as the cold water temperature.

In an exemplary embodiment, the processor 50 learns a hot water temperature by sending a signal to the electronic valve 32 to activate and flow water primarily from the hot water line 26. As a result, primarily hot water will be delivered through the discharge outlet 24 of the fitting 10 or the faucet 12. As used herein, “flow water primarily from the hot water line” and “primarily hot water” mean flowing water and water that include more hot water than cold water. The temperature sensor 74 detects the temperature of the water and sends a signal to the processor 50 indicating the detected temperature. The processor 50 receives the signal from the temperature sensor 74. The temperature sensor 74 continues to detect the temperature of the water and to send signals to the processor 50 indicating the detected temperatures, and the processor 50 continues to receive the signals from the temperature sensor 74, until: (1) the detected temperature has become stable (e.g., has not changed for a period of time sufficient to ensure that the detected temperature is approximately equal to a temperature of the flowing water, such as for thirty seconds), (2) the detected temperature has reached a specified temperature (e.g., is above any temperature of water that could be achieved by cold water warming in the cold water line 28), or (3) water has been flowing for a specified period of time (e.g., a period of time necessary for water sitting in the hot water line 26 to be purged). The processor then saves the detected temperature as the hot water temperature.

In an exemplary embodiment, once the processor 50 has learned at least one of the cold water temperature and the hot water temperature, the processor 50 determines if the hot water line 26 is connected to the hot water supply 34 and the cold water line 28 is connected to the cold water supply 36 (i.e., if the hot water line 26 and the cold water line 28 are reversed).

In an exemplary embodiment, the processor 50 initially determines if the hot water line 26 and the cold water line 28 are reversed by comparing the cold water temperature to the hot water temperature. In an exemplary embodiment, if the cold water temperature is greater than the hot water temperature, then the hot water line 26 and the cold water line 28 are reversed. In an exemplary embodiment, if the cold water temperature is greater than the hot water temperature by a differential water temperature threshold (e.g., 1° F.), then the hot water line 26 and the cold water line 28 are reversed. The differential water temperature threshold eliminates the possibility of the cold water temperature being greater than the hot water temperature for reasons other than the hot water line 26 and the cold water line 28 are reversed. In these instances (i.e., the lines are reversed), further action needs to be taken (as will be described below). In an exemplary embodiment, if the cold water temperature is not greater than or is less than the hot water temperature, then the hot water line 26 and the cold water line 28 are not reversed. In an exemplary embodiment, if the cold water temperature is not greater than or is less than the hot water temperature by the differential water temperature threshold, then the hot water line 26 and the cold water line 28 are not reversed. In these instances (i.e., the lines are not reversed), no further action needs to be taken.

In an exemplary embodiment, the cold supply temperature threshold, the hot supply temperature threshold, the differential supply temperature threshold, the cold water temperature threshold, the hot water temperature threshold, and the differential water temperature threshold may vary depending upon the geographic region in which the fitting 10 or the faucet 12 is installed and operated as the geographic region can impact the temperature of water in the hot water line 26, the hot water supply 34, the cold water line 28, and the cold water supply 36 (e.g., ground water is warmer in southern regions than in northern regions, and water in hot supply lines will cool down and water in cold supply lines will warm up at a different rate in southern regions than in northern regions). The cold supply temperature threshold, the hot supply temperature threshold, the differential supply temperature threshold, the cold water temperature threshold, the hot water temperature threshold, and the differential water temperature threshold may also vary depending upon the time of year when the fitting 10 or the faucet 12 is installed and operated as the time of year can impact the temperature of water in the hot water line 26, the hot water supply 34, the cold water line 28, and the cold water supply 36 (e.g., ground water is warmer during the summer than in the winter, and water in hot supply lines will cool down and water in cold supply lines will warm up at a different rate in the summer than in the winter).

In an exemplary embodiment, if the installation check system determines that the hot water line 26 was not properly connected to the hot water supply 34 and the cold water line 28 was not properly connected to the cold water supply 36 during installation (i.e., the hot water line 26 and the cold water line 28 are reversed), the installation check system notifies the user of the improper installation and requests instructions from the user regarding the correction of the connection of the hot water line 26 to the hot water supply 34 and the connection of the cold water line 28 to the cold water supply 36.

In an exemplary embodiment, if the installation check system detects that the hot water line 26 was not properly connected to the hot water supply 34 and the cold water line 28 was not properly connected to the cold water supply 36 during installation (i.e., the hot water line 26 and the cold water line 28 are reversed), the installation check system automatically corrects the connection of the hot water line 26 to the hot water supply 34 and the connection of the cold water line 28 to the cold water supply 36.

In an exemplary embodiment, to correct the connection of the hot water line 26 to the hot water supply 34 and the connection of the cold water line 28 to the cold water supply 36 (either upon instruction from the user or automatically), the processor 50 designates the initial hot water electronic valve 32h as the new cold water electronic valve 32c and designates the initial cold water electronic valve 32c as the new hot water electronic valve 32h.

In an exemplary embodiment, the installation check system detects whether the hot water line 26 was properly connected to the hot water supply 34 and the cold water line 28 was properly connected to the cold water supply 36 shortly after installation of the fitting 10 or the faucet 12. In an exemplary embodiment, the installation check system periodically detects whether the hot water line 26 is properly connected to the hot water supply 34 and the cold water line 28 is properly connected to the cold water supply 36 throughout the operating life of the fitting 10 or the faucet 12.

In an exemplary embodiment, the fitting 10 or the faucet 12 includes a hot water or child safety mode. The hot water or child safety mode enables the user to set a maximum temperature which applies to a house or other structure in which the fitting 10 or the faucet 12 is located. The hot water or child safety mode can be enabled and disabled by the user. When hot water or safety mode is enabled, the fitting 10 or the faucet 12 is only able to dispense water at or below the set maximum temperature. When hot water or child safety mode is disabled, the fitting 10 or the faucet 12 is able to dispense water above the set maximum temperature. In an exemplary embodiment, the installation check system disables the hot water or child safety mode prior to detecting whether the hot water line 26 was properly connected to the hot water supply 34 and the cold water line 28 was properly connected to the cold water supply 36 during installation of the fitting 10 or the faucet 12.

One of ordinary skill in the art will now appreciate that the present invention provides an electronic plumbing fixture fitting, such as an electronic faucet, including an installation check system. Although the present invention has been shown and described with reference to particular embodiments, equivalent alterations and modifications will occur to those skilled in the art upon reading and understanding this specification. The present invention includes all such equivalent alterations and modifications and is limited only by the scope of the following claims in light of their full scope of equivalents.

What is claimed is:

1. An electronic plumbing fixture fitting, comprising:
a discharge outlet, the discharge outlet operable to deliver water;
an electronic valve, the electronic valve operable to permit flow of water through the discharge outlet when the electronic valve is activated and to not permit flow of water through the discharge outlet when the electronic valve is deactivated, the electronic valve operable to control a temperature of water flowing through the discharge outlet;
a hot water line, the hot water line including an upstream end and a downstream end, the upstream end operable to connect to a hot water supply, the downstream end operable to connect to the electronic valve, the hot water line operable to supply hot water to the electronic valve;
a cold water line, the cold water line including an upstream end and a downstream end, the upstream end operable to connect to a cold water supply, the downstream end operable to connect to the electronic valve, the cold water line operable to supply cold water to the electronic valve;
a temperature sensor, the temperature sensor operable to detect a temperature of water; and
a processor, the processor operable to communicate with each of the electronic valve and the temperature sensor regarding a desired temperature of water and the detected temperature of water;
wherein the processor is operable to send a signal to the electronic valve to flow water from the cold water line;
wherein the electronic valve is operable to receive the signal from the processor and to flow water from the cold water line;
wherein the temperature sensor is operable to detect a temperature of water flowing at least one of in the hot water line, in the cold water line, in the electronic valve, and from the electronic valve and to send a signal to the processor indicating the detected temperature;
wherein the processor is operable to receive the signal from the temperature sensor and to save the detected temperature as the cold supply temperature;
wherein the processor is operable to compare the cold supply temperature to a cold supply temperature threshold; and
wherein, if the cold supply temperature is greater than the cold supply temperature threshold, then the hot water line and the cold water line are reversed.

2. The electronic plumbing fixture fitting of claim 1,
wherein the processor is operable to send a signal to the electronic valve to flow water from the hot water line;
wherein the electronic valve is operable to receive the signal from the processor and to flow water from the hot water line;
wherein the temperature sensor is operable to detect a temperature of water flowing at least one of in the hot water line, in the cold water line, in the electronic valve, and from the electronic valve and to send a signal to the processor indicating the detected temperature;
wherein the processor is operable to receive the signal from the temperature sensor and to save the detected temperature as the hot supply temperature;
wherein, if the cold supply temperature is less than the cold supply temperature threshold, then the processor is operable to compare the cold supply temperature to the hot supply temperature;
wherein, if the cold supply temperature is greater than the hot supply temperature, then the hot water line and the cold water line are reversed; and
wherein, if the cold supply temperature is less than the hot supply temperature, then the hot water line and the cold water line are not reversed.

3. The electronic plumbing fixture fitting of claim 1, wherein the temperature sensor is operable to detect the temperature of the water until the detected temperature has not changed for a predetermined period of time.

4. The electronic plumbing fixture fitting of claim 1, wherein the temperature sensor is operable to detect the temperature of the water until the detected temperature has reached a predetermined temperature.

5. The electronic plumbing fixture fitting of claim 1, wherein the temperature sensor is operable to detect the temperature of the water until the water has been flowing for a predetermined period of time.

6. The electronic plumbing fixture fitting of claim 1,
further including a user input module, the user input module operable to communicate with a user;
wherein, if the hot water line and the cold water line are reversed, the processor is operable to send a signal to the user input module indicating that the hot water line and the cold water line are reversed; and
wherein the user input module is operable to receive the signal from the processor and to notify the user that the hot water line and the cold water line are reversed and request instructions from the user regarding correction of the connection of the hot water line and the cold water line.

7. The electronic plumbing fixture fitting of claim 1, wherein, if the hot water line and the cold water line are reversed, the processor is operable to automatically correct the connection of the hot water line and the cold water line by reversing a designation of the hot water line and the cold water line.

8. An electronic plumbing fixture fitting, comprising:
a discharge outlet, the discharge outlet operable to deliver water;
an electronic valve, the electronic valve operable to permit flow of water through the discharge outlet when the electronic valve is activated and to not permit flow of water through the discharge outlet when the electronic valve is deactivated, the electronic valve operable to control a temperature of water flowing through the discharge outlet;
a hot water line, the hot water line including an upstream end and a downstream end, the upstream end operable to connect to a hot water supply, the downstream end operable to connect to the electronic valve, the hot water line operable to supply hot water to the electronic valve;
a cold water line, the cold water line including an upstream end and a downstream end, the upstream end operable to connect to a cold water supply, the downstream end operable to connect to the electronic valve, the cold water line operable to supply cold water to the electronic valve;
a temperature sensor, the temperature sensor operable to detect a temperature of water; and
a processor, the processor operable to communicate with each of the electronic valve and the temperature sensor regarding a desired temperature of water and the detected temperature of water;
wherein the processor is operable to send a signal to the electronic valve to flow water from the hot water line;
wherein the electronic valve is operable to receive the signal from the processor and to flow water from the hot water line;
wherein the temperature sensor is operable to detect a temperature of water flowing at least one of in the hot water line, in the cold water line, in the electronic valve, and from the electronic valve and to send a signal to the processor indicating the detected temperature;
wherein the processor is operable to receive the signal from the temperature sensor and to save the detected temperature as the hot supply temperature;
wherein the processor is operable to compare the hot supply temperature to a hot supply temperature threshold; and
wherein, if the hot supply temperature is greater than the hot supply temperature threshold, then the hot water line and the cold water line are not reversed.

9. The electronic plumbing fixture fitting of claim 8,
wherein the processor is operable to send a signal to the electronic valve to flow water from the cold water line;
wherein the electronic valve is operable to receive the signal from the processor and to flow water from the cold water line;
wherein the temperature sensor is operable to detect a temperature of water flowing at least one of in the hot water line, in the cold water line, in the electronic valve, and from the electronic valve and to send a signal to the processor indicating the detected temperature;
wherein the processor is operable to receive the signal from the temperature sensor and to save the detected temperature as the cold supply temperature;
wherein, if the hot supply temperature is less than the hot supply temperature threshold, then the processor is operable to compare the cold supply temperature to the hot supply temperature;
wherein, if the cold supply temperature is greater than the hot supply temperature, then the hot water line and the cold water line are reversed; and
wherein, if the cold supply temperature is less than the hot supply temperature, then the hot water line and the cold water line are not reversed.

10. The electronic plumbing fixture fitting of claim 8, wherein the temperature sensor is operable to detect the temperature of the water until the detected temperature has not changed for a predetermined period of time.

11. The electronic plumbing fixture fitting of claim 8, wherein the temperature sensor is operable to detect the temperature of the water until the detected temperature has reached a predetermined temperature.

12. The electronic plumbing fixture fitting of claim 8, wherein the temperature sensor is operable to detect the temperature of the water until the water has been flowing for a predetermined period of time.

13. The electronic plumbing fixture fitting of claim 8,
further including a user input module, the user input module operable to communicate with a user;
wherein, if the hot water line and the cold water line are reversed, the processor is operable to send a signal to the user input module indicating that the hot water line and the cold water line are reversed; and
wherein the user input module is operable to receive the signal from the processor and to notify the user that the hot water line and the cold water line are reversed and request instructions from the user regarding correction of the connection of the hot water line and the cold water line.

14. The electronic plumbing fixture fitting of claim 8, wherein, if the hot water line and the cold water line are reversed, the processor is operable to automatically correct the connection of the hot water line and the cold water line by reversing a designation of the hot water line and the cold water line.

15. An electronic plumbing fixture fitting, comprising:
a discharge outlet, the discharge outlet operable to deliver water;
an electronic valve, the electronic valve operable to permit flow of water through the discharge outlet when the electronic valve is activated and to not permit flow of water through the discharge outlet when the electronic valve is deactivated, the electronic valve operable to control a temperature of water flowing through the discharge outlet;
a hot water line, the hot water line including an upstream end and a downstream end, the upstream end operable to connect to a hot water supply, the downstream end operable to connect to the electronic valve, the hot water line operable to supply hot water to the electronic valve;
a cold water line, the cold water line including an upstream end and a downstream end, the upstream end operable to connect to a cold water supply, the downstream end operable to connect to the electronic valve, the cold water line operable to supply cold water to the electronic valve;
a temperature sensor, the temperature sensor operable to detect a temperature of water; and
a processor, the processor operable to communicate with each of the electronic valve and the temperature sensor regarding a desired temperature of water and the detected temperature of water;
wherein the processor is operable to send a signal to the electronic valve to flow water primarily from the cold water line;
wherein the electronic valve is operable to receive the signal from the processor and to flow water primarily from the cold water line;
wherein the temperature sensor is operable to detect a temperature of the water flowing at least one of in the hot water line, in the cold water line, in the electronic valve, and from the electronic valve and to send a signal to the processor indicating the detected temperature;
wherein the processor is operable to receive the signal from the temperature sensor and to save the detected temperature as the cold water temperature;
wherein the processor is operable to send a signal to the electronic valve to flow water primarily from the hot water line;
wherein the electronic valve is operable to receive the signal from the processor and to flow water primarily from the hot water line;
wherein the temperature sensor is operable to detect a temperature of the water flowing at least one of in the hot water line, in the cold water line, in the electronic valve, and from the electronic valve and to send a signal to the processor indicating the detected temperature;
wherein the processor is operable to receive the signal from the temperature sensor and to save the detected temperature as the hot water temperature;
wherein the processor is operable to compare the cold water temperature to the hot water temperature;
wherein, if the cold water temperature is greater than the hot water temperature, then the hot water line and the cold water line are reversed; and
wherein, if the cold water temperature is less than the hot water temperature, then the hot water line and the cold water line are not reversed.

16. The electronic plumbing fixture fitting of claim 15, wherein the temperature sensor is operable to detect the temperature of the water until the detected temperature has not changed for a predetermined period of time.

17. The electronic plumbing fixture fitting of claim 15, wherein the temperature sensor is operable to detect the temperature of the water until the detected temperature has reached a predetermined temperature.

18. The electronic plumbing fixture fitting of claim 15, wherein the temperature sensor is operable to detect the temperature of the water until the water has been flowing for a predetermined period of time.

19. The electronic plumbing fixture fitting of claim 15,
further including a user input module, the user input module operable to communicate with a user;
wherein, if the hot water line and the cold water line are reversed, the processor is operable to send a signal to the user input module indicating that the hot water line and the cold water line are reversed; and
wherein the user input module is operable to receive the signal from the processor and to notify the user that the hot water line and the cold water line are reversed and request instructions from the user regarding correction of the connection of the hot water line and the cold water line.

20. The electronic plumbing fixture fitting of claim 15, wherein, if the hot water line and the cold water line are reversed, the processor is operable to automatically correct the connection of the hot water line and the cold water line by reversing a designation of the hot water line and the cold water line.
